(19) United States
(12) Patent Application Publication
(10) Pub. No.: US 2016/0026646 A1
(43) Pub. Date: Jan. 28, 2016

(54) RECORDING MEDIUM HAVING DATA RECORDED THEREIN IN DATA FILE FORMAT STRUCTURE FOR VISUALIZATION OF LARGE CAPACITY CFD PARALLEL DATA AND METHOD FOR GENERATING SAID DATA FILE FORMAT STRUCTURE

(71) Applicant: KOREA INSTITUTE OF SCIENCE AND TECHNOLOGY INFORMATION, Daejeon (KR)

(72) Inventors: Min Ah KIM, Daejeon (KR); Se Hoon LEE, Daejeon (KR); Joong Youn LEE, Daejeon (KR)

(21) Appl. No.: 14/647,730

(22) PCT Filed: Nov. 26, 2013
(86) PCT No.: PCT/KR2013/010791

§ 371 Date: Aug. 14, 2015

(30) Foreign Application Priority Data
Nov. 28, 2012 (KR) 10-2012-0136287

(51) Int. Cl. G06F 17/30

(52) U.S. Cl. CPC G06F 17/30076; G06F 17/3012; G06F 17/30141

(57) ABSTRACT

The present invention relates to a recording medium having data recorded therein in a data file format structure for visualization of large capacity CFD parallel data and to a method for generating said data file format structure, in which the large capacity data is generated and stored or recorded in the data file format structure of a structured grid or an unstructured grid in processing large capacity CFD data in parallel to each other and visualizing the data.

### TECHNICAL FIELD

The present invention relates to a recording medium on which data has been recorded in a data film format structure for visualizing a large capacity of computational fluid dynamics (CFD) parallel data and a method of generating the data file format structure, wherein a large capacity of data can be processed and visualized within a short time by generating data in a data file format structure capable of increasing processing speed of the data and storing or recording a large capacity of data of the generated data file format structure in visualizing large capacity of CFD data by processing the CFD data in parallel.

### BACKGROUND ART

Computational fluid dynamics (CFD) is a field in which a floating analysis is simulated and performed on a computer. In the CFD field, visualization, that is, post-processing, means that data is represented using a figure so that the results of an analysis can be understood more intuitively. Commercial tools for performing CFD include Fluent and CFD++. There is also an analysis tool implemented using various open sources, such as OpenFOAM.

In such tools, visualization for post-processing can be performed in each tool, but a level of visualization provided by an analysis tool is very low. Accordingly, visualization, that is, post-processing, is commonly performed using a separate visualization tool.

Tools that are used for performing only visualization on the results of an analysis include commercial tools, such as Tecplot and Ensight, and Paraview provided as an open source. Such tools have their unique data formats.

The aforementioned analysis tools can generate data in data formats used by such visualization tools. Accordingly, in the visualization tools, an analysis tool performs visualization using data generated for each visualization tool.

Data generated by an existing floating analysis tool has a data format in which parallel processing for a large capacity of data has not been taken into consideration. If data is great, the time taken to read the data accounts for a very significant portion. In order to reduce the time taken to read data, parallel input/output (I/O) needs to be performed, but existing data formats have structures in which parallel I/O is not easy to be implemented. In order to improve efficiency of parallel I/O, access to the same file must be small as far as possible. The reason for this is that if a plurality of processes accesses a single file for parallel processing, access to the file itself becomes a bottleneck. Furthermore, if the same file needs to be accessed, it is advantageous if the size of the file is small as far as possible. The reason for this is that bottleneck can be solved within a short time when the size of a file is small.

In the case of the Tecplot format, parallel I/O is impossible when a visualization tool reads data because a large capacity of data is stored in a single file. In the case of time-varying data, separate meta information that will describe the data of each time step is required, but is not supported.

In the case of Ensight, there is a format that supports a data format for parallel I/O, but a single data file is stored for each value. Accordingly, decomposing for a large capacity of data having a great mesh is not taken into consideration.

In the case of Paraview, various data formats for vtk, that is, a visualization tool kit used by Paraview, are supported. However, the vtk file format is a data format for common visualization, and has a disadvantage in that it does not include a method of describing meta data capable of describing the characteristics of time-varying data, such as CFD.

### DISCLOSURE

### Technical Problem

An object of the present invention for solving the aforementioned disadvantages is to provide a recording medium on which data has been recorded in a data film format structure for visualizing a large capacity of CFD parallel data and a method of generating the data file format structure, wherein a large capacity of CFD data can be processed and visualized within a short time by generating the CFD data in a data file format structure capable of increasing processing speed of the large capacity of CFD data in visualizing the large capacity of CFD data by processing the CFD data in parallel and storing or recording a large capacity of data of the generated data file format structure.

### Technical Solution

In accordance with an aspect of the present invention for achieving the above object, in a recording medium on which data has been recorded in a data file format structure of a structured grid for visualizing a large capacity of CFD parallel data, there is provided a recording medium on which data has been recorded in a data file format structure of a structured grid for visualizing a large capacity of CFD parallel data, wherein the data file format structure of the structured grid includes a meta data unit which describes feature information about all data, including the number and IDs of elements of a mesh and data, the number and IDs of time steps, and the number and IDs of the values of the data; a mesh directory unit in which a directory of an element unit and the directory of each of the time steps within the element have been structured in the grid structure with respect to the mesh; and a data directory unit in which a directory of an element unit and the directory of each of the time steps within the element have been structured in the grid structure and the directory of one or more values has been structured in the directory of each time step with respect to the data.

Furthermore, the meta data unit may include a list of values calculated through CFD and the mesh corresponding to locations where the values are present.

Furthermore, one or more block data may be stored in a file form in the directory of each time step of the mesh directory unit, and one or more block data may be stored in a file form in the directory of each value of the data directory unit.

Furthermore, the mesh directory unit may be redefined as a list of the elements, each point of the mesh may be represented in order of x, y, and z, the element may include items of a unique ID, value, and dimension, the ID is a unique ID to identify the element in a single data set, and the value may be a list of physical values that are owned by the element.

Furthermore, each element may be formed of several blocks, a plurality of dimensions of the mesh of the block may be present in a single element, the dimensions may describe different dimensions present in the element, and the dimension may include a list of blocks having unique IDs and dimension size and the same dimension.

Meanwhile, in accordance with another aspect of the present invention for achieving the above object, in a recording medium on which data has been recorded in a data file format structure of an unstructured grid for visualizing a large capacity of CFD parallel data, there is provided a recording medium on which data has been recorded in a data file format structure of an unstructured grid for visualizing a large capacity of CFD parallel data, wherein the data file format structure of the unstructured grid includes a meta data unit which describes feature information about all data, including the number and IDs of elements of a mesh, cell information, and data, the number and IDs of time steps, and the number and IDs of the values of the data; a mesh directory unit in which a directory of an element unit and the directory of each of the time steps within the element have been structured in the grid structure with respect to the mesh; a cell information directory unit which stores information about a cell formed by the points of a block designated within the mesh and in which a directory of an element unit and the directory of each of the time steps within the element have been structured in the grid structure with respect to the cell information; and a data directory unit in which a directory of an element unit and the directory of each of the time steps within the element have been structured in the grid structure and the directory of one or more values has been structured in the directory of each time step with respect to the data.

Furthermore, the meta data unit may include the unstructured grid, the number of time steps, value information about a value list, the number and IDs of elements, the number of blocks, the number of dimensions of the mesh, and element information about the locations of points.

Furthermore, the cell information directory unit may be redefined as a list of the elements, each point of the mesh may be represented in order of x, y, and z, the element may include items of a unique ID, value, and dimension, the ID may be a unique ID to identify the element in a single data set, and the value may be a list of physical values that are owned by the element.

Furthermore, each element may be formed of several blocks, a plurality of dimensions of the mesh of the block may be present in a single element, the dimensions may describe different dimensions present in the element, and the dimension may include a list of blocks having unique IDs and dimension size and the same dimension.

Meanwhile, in accordance with yet another aspect of the present invention for achieving the above object, in a recording medium on which data has been recorded in a binary data file format structure of a structured grid for visualizing a large capacity of CFD parallel data, there is provided a recording medium on which data has been recorded in a binary data file format structure of a structured grid for visualizing a large capacity of CFD parallel data, wherein the binary data file format structure of the structured grid includes a meta data unit which describes feature information about all data, including a mesh that determines the size of a block based on values of i, j, and k corresponding to a dimension and a value regarding the value of a value owned by points of the mesh; a mesh block unit which describes grid point coordinates of the mesh with respect to the mesh, describes coordinates corresponding to the number of i, j, and k values corresponding to the dimension, and stores the coordinates a binary data format corresponding to the size of each block described in the meta data unit; and a value block unit which describes a physical value in the points of the mesh.

Furthermore, the mesh block unit may separate the file of a mesh in which the values of i, j, and k described in the dimension are different and store the separated file.

Furthermore, the mesh block unit may describe the number of points to which a corresponding block belongs (mesh dimension size) and the coordinates of the points in a mesh type and describe the coordinate system of the points of the mesh in a mesh dimension.

Furthermore, the value block unit may describe the number of points to which a corresponding block belongs (mesh dimension size) and the data type of a value.

Meanwhile, in accordance with yet another aspect of the present invention for achieving the above object, in a recording medium on which data has been recorded in a binary data file format structure of an unstructured grid for visualizing a large capacity of CFD parallel data, there is provided a recording medium on which data has been recorded in a binary data file format structure of an unstructured grid for visualizing a large capacity of CFD parallel data, wherein the binary data file format structure of the unstructured grid includes a mesh file unit which describes coordinates of a mesh point; a cell information (Cellinfo) file unit which describes cell information formed of points; and a value file unit representing values calculated for each mesh.

Furthermore, the mesh file unit may describe the number of points that form the mesh with respect to the points of the mesh, the number of cells formed by the points, and the number of points of a cell that belongs to various cells formed by the points and that has the greatest number of points.

Furthermore, the cell information file unit may store cell information corresponding to a single mesh block in a form including a cell information list, a cell type array, and a cell location array.

Furthermore, the cell information list may be stored in each mesh block one by one and may be a file for storing information about a cell, the cell type array may store the type of cell by the number of cells, the number of points forming a single cell may be determined by the cell type, and the cell location array may store an offset where the cell information may be placed in the cell information list.

Furthermore, in the value file unit, data may be stored in an element directory, a time step directory, and a value directory, and an actual value corresponding to a physical value may be stored.

Furthermore, the value file unit may store data by the number of cells if a value present in the element directory is cell-centered and may store data by the number of points if a value present in the element directory is a point, the value nDim may be 1 in case of scalar, the value nDim may be 2 in case of a two-dimensional vector Ventor, and the value nDim may be 3 in case of a three dimension.

Meanwhile, in accordance with yet another aspect of the present invention for achieving the above object, in a method of generating a data file format structure of a structured grid for visualizing a large capacity of CFD parallel data, there is provided a method of generating a data file format structure of a structured grid for visualizing a large capacity of CFD parallel data, including steps of (a) generating meta data which describes feature information about all data, including the number and IDs of elements of a mesh and data, the number and IDs of time steps, and the number and IDs of the values of the data; (b) generating a mesh directory in which a directory of an element unit and the directory of each of the time steps within the element have been structured in the grid structure with respect to the mesh; and (c) generating a data directory in which a directory of an element unit and the directory of each of the time steps within the element have been structured in the grid structure and the directory of one or more values has been structured in the directory of each time step with respect to the data.

Furthermore, in the step (a), the meta data may include a list of values calculated through CFD and the mesh corresponding to locations where the values are present.

Furthermore, in the step (b), one or more block data may be stored in a file form in the directory of each time step of the mesh directory unit, and one or more block data may be stored in a file form in the directory of each value of the data directory unit.

Furthermore, in the step (b), the mesh directory may be redefined as a list of the elements, each point of the mesh may be represented in order of x, y, and z, the element may include items of a unique ID, value, and dimension, the ID may be a unique ID to identify the element in a single data set, and the value may be a list of physical values that are owned by the element.

Furthermore, each element may be formed of several blocks, a plurality of dimensions of the mesh of the block may be present in a single element, the dimensions may describe different dimensions present in the element, and the dimension may include a list of blocks having unique IDs and dimension size and the same dimension.

Meanwhile, in accordance with yet another aspect of the present invention for achieving the above object, in a method of generating a data file format structure of an unstructured grid for visualizing a large capacity of CFD parallel data, there is provided a method of generating a data file format structure of an unstructured grid for visualizing a large capacity of CFD parallel data, including steps of (a) generating meta data which describes feature information about all data, including the number and IDs of elements of a mesh, cell information, and data, the number and IDs of time steps, and the number and IDs of the values of the data; (b) generating a mesh directory in which a directory of an element unit and the directory of each of the time steps within the element have been structured in the grid structure with respect to the mesh; (c) generating a cell information directory which may store information about a cell formed by the points of a block designated within the mesh and in which a directory of an element unit and the directory of each of the time steps within the element have been structured in the grid structure with respect to the cell information; and (d) generating a data directory in which a directory of an element unit and the directory of each of the time steps within the element have been structured in the grid structure and the directory of one or more values has been structured in the directory of each time step with respect to the data.

Furthermore, in the step (a), the unstructured grid, the number of time steps, value information about a value list, the number and IDs of elements, the number of blocks, the number of dimensions of the mesh, and element information about the locations of points may be included in the meta data.

Furthermore, in the step (c), the cell information directory may be redefined as a list of the elements, each point of the mesh may be represented in order of x, y, and z, the element may include items of a unique ID, value, and dimension, the ID may be a unique ID to identify the element in a single data set, and the value may be a list of physical values that are owned by the element.

Furthermore, each element may be formed of several blocks, a plurality of dimensions of the mesh of the block may be present in a single element, the dimensions may describe different dimensions present in the element, and the dimension may include a list of blocks having unique IDs and dimension size and the same dimension.

Meanwhile, in accordance with yet another aspect of the present invention for achieving the above object, in a method of generating a binary data file format structure of a structured grid for visualizing a large capacity of CFD parallel data, there is provided a method of generating a binary data file format structure of a structured grid for visualizing a large capacity of CFD parallel data, including steps of (a) generating meta data which describes feature information about all data, including a mesh that determines the size of a block based on values of i, j, and k corresponding to a dimension and a value regarding the value of a value owned by points of the mesh; (b) generating a mesh block unit which describes grid point coordinates of the mesh with respect to the mesh, describes coordinates corresponding to the number of i, j, and k values corresponding to the dimension, and may store the coordinates a binary data format corresponding to the size of each block described in the meta data unit; and (c) generating a value block unit which describes a physical value in the points of the mesh.

Furthermore, in the step (b), the mesh block unit may separate the file of a mesh in which the values of i, j, and k described in the dimension are different and store the separated file.

Furthermore, in the step (b), the mesh block unit may describe the number of points to which a corresponding block belongs (mesh dimension size) and the coordinates of the points in a mesh type and describe the coordinate system of the points of the mesh in a mesh dimension.

Furthermore, in the step (b), the value block unit may describe the number of points to which a corresponding block belongs (mesh dimension size) and the data type of a value.

Meanwhile, in accordance with yet another aspect of the present invention for achieving the above object, in a method of generating a binary data file format structure of an unstructured grid for visualizing a large capacity of CFD parallel data, there is provided a method of generating a binary data file format structure of an unstructured grid for visualizing a large capacity of CFD parallel data, including steps of (a) generating a mesh file which describes the coordinates of a mesh point; (b) generating a cell information (Cellinfo) file which describes cell information formed of points; and (c) generating a value file representing values calculated for each mesh.

Furthermore, in the step (a), the number of points that form the mesh with respect to the points of the mesh, the number of cells formed by the points, and the number of points of a cell that belongs to various cells formed by the points and that has the greatest number of points may be described in the mesh file.

Furthermore, in the step (b), cell information corresponding to a single mesh block in a form including a cell information list, a cell type array, and a cell location array may be stored in the cell information file.

Furthermore, the cell information list may be stored in each mesh block one by one and may be a file for storing information about a cell, the cell type array may store the type of a cell by the number of cells, the number of points forming a single cell may be determined by the cell type, and the cell location array may store an offset where the cell information may be placed in the cell information list.

Furthermore, in the step (c), in the value file, data may be stored in an element directory, a time step directory, and a value directory, and an actual value corresponding to a physical value may be stored.

Furthermore, the value file may store data by the number of cells if a value present in the element directory is cell-centered and may store data by the number of points if a value present in the element directory is a point, the value nDim may be 1 in case of scalar, the value nDim may be 2 in case of a two-dimensional vector Ventor, and the value nDim may be 3 in case of a three dimension.

### Advantageous Effects

In accordance with the present invention, meta data formats generated by existing CFD calculation tools have described or calculated all information used in calculation in addition to information required for visualization in order to perform post-processing on the results of the calculation and have omitted information used in visualization or described only information about a result file. In contrast, according to the present invention, all the data sets can be checked at a look because only information that may be described in common is extracted from all the data sets depending on structured and unstructured characteristics of meta data and the extracted information is proposed.

Furthermore, in general, for the processing large capacity of data, there is a need for a structure in which cluster nodes can independently read data for parallel I/O because each node individually reads data using a cluster node and a file sharing system and parallel I/O is implemented. In a data structure according to the present invention, loads can be easily distributed respective nodes because a directory is configured based on a structure and principle in which cluster nodes can easily access the directory for parallel I/O. In existing files, all information is represented in a single file regardless of elements or time steps and values. In contrast, in the data structure according to the present invention, directory information itself can show data configuration information because such information is represented in a directory structure, and efficiency of parallel I/O can be improved because information can be separated and read for each node and CPU when parallel processing is performed.

Furthermore, a data representation format according to the present invention is not different from an existing binary data file format, but represents common information using meta data and stores only the purest data region that is required in a single file form for each block that may be processed by each node, thereby being capable of improving efficiency of input/output (I/O).

### DESCRIPTION OF DRAWINGS

FIG. 1 is a diagram illustrating an example of a recording medium on which data has been recorded in the data file format structure of a structured grid for visualizing a large capacity of CFD parallel data in accordance with an embodiment of the present invention.

FIG. 2 is a diagram illustrating an example of a recording medium on which data has been recorded in the data file format structure of an unstructured grid for visualizing a large capacity of CFD parallel data in accordance with another embodiment of the present invention.

FIG. 3 is a diagram illustrating an example of a recording medium on which data has been recorded in the binary data file format structure of a structured grid for visualizing a large capacity of CFD parallel data in accordance with another embodiment of the present invention.

FIG. 4 is a diagram illustrating an example of recording medium on which data has been recorded in the binary data file format structure of an unstructured grid for visualizing a large capacity of CFD parallel data in accordance with another embodiment of the present invention.

FIG. 5 is a diagram illustrating an operating flowchart illustrating a method of generating a data file format structure of a structured grid for visualizing large capacity of CFD parallel data in accordance with an embodiment of the present invention.

FIG. 6 is a diagram illustrating an example of meta data in accordance with an embodiment of the present invention.

FIG. 7 is a diagram illustrating an example of the elements of a mesh directory in the data file format structure of a structured grid in accordance with an embodiment of the present invention.

FIG. 8 is a diagram illustrating an operating flowchart illustrating a method of generating the data file format structure of an unstructured grid for visualizing large capacity of CFD parallel data in accordance with another embodiment of the present invention.

FIG. 9 is a diagram illustrating an example of meta data formed of values and elements in the data file format structure of an unstructured grid in accordance with an embodiment of the present invention.

FIG. 10 is a diagram illustrating an operating flowchart illustrating a method of generating the binary data file format structure of a structured grid for visualizing a large capacity of CFD parallel data in accordance with another embodiment of the present invention.

FIG. 11 is a diagram illustrating a case where a mesh dimension is 3 in the binary data file format structure of a structured grid in accordance with an embodiment of the present invention.

FIG. 12 is a diagram illustrating a case where a value is zero (0) in the binary data file format structure of a structured grid in accordance with an embodiment of the present invention.

FIG. 13 is a diagram illustrating an operating flowchart illustrating a method of generating the binary data file format structure of an unstructured grid in accordance with another embodiment of the present invention.

FIG. 14 is a diagram illustrating the structure of a mesh file in the binary data file format structure of an unstructured grid in accordance with another embodiment of the present invention.

FIG. 15 is a diagram illustrating the structure of a cell information file in the binary data file format structure of an unstructured grid in accordance with another embodiment of the present invention.

<Description of reference numerals>

| | |
|---|---|
| 100: recording medium on which data has | |
| been recorded in data file format | |
| structure of structured grid | |
| 110: meta data unit | 120: mesh directory unit |
| 130: data directory unit | |
| 200: recording medium on which data has | |
| been recorded in data file format | |
| structure of unstructured grid | |
| 210: meta data unit | 220: mesh directory unit |
| 230: cell information (Cellinfo) directory unit | |
| 240: data directory unit | |
| 300: recording medium on which data has | |
| been recorded in binary data file format | |
| structure of structured grid | |
| 310: meta data unit | 320: mesh block unit |
| 330: value block unit | |
| 400: recording medium on which data has | |
| been recorded in binary data file format | |
| structure of unstructured grid | |
| 410: mesh file unit | |
| 420: cell information (Cellinfo) file unit | |
| 430: value file unit | |

### MODE FOR INVENTION

The present invention may be modified in various ways and may be implemented to have several embodiments. Specific embodiments are illustrated in the drawings and are described in detail. It is however to be understood that the present invention is not intended to be limited to the specific embodiments and the present invention includes all modifications, equivalents, and substitutions which fall within the spirit and technical scope of the present invention.

Embodiments of a recording medium on which data has been recorded in a data film format structure for visualizing a large capacity of CFD parallel data and a method of generating the data file format structure according to the present invention are described in detail with reference to the accompanying drawings. In describing the embodiments with reference to the accompanying drawings, the same or corresponding elements are assigned the same reference numerals, and redundant descriptions thereof are omitted.

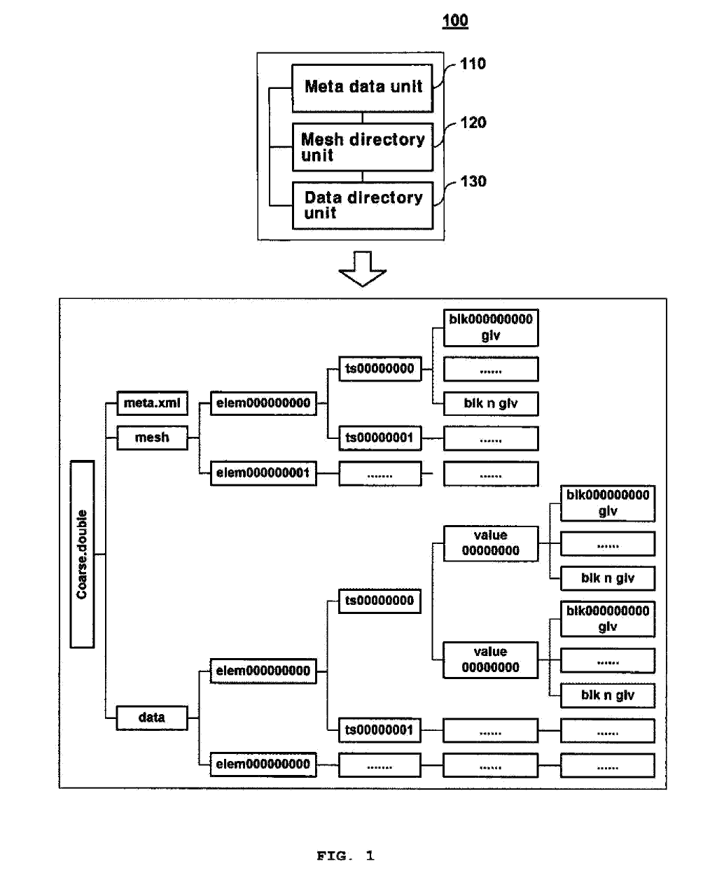

FIG. 1 is a diagram illustrating an example of recording medium on which data has been recorded in the data file format structure of a structured grid for visualizing a large capacity of CFD parallel data in accordance with an embodiment of the present invention.

As illustrated in FIG. 1, the recording medium 100 on which data has been recorded in the data file format structure of a structured grid for visualizing a large capacity of CFD parallel data in accordance with an embodiment of the present invention includes a meta data unit 110, a mesh directory unit 120, and a data directory unit 130.

The meta data unit 110 describes feature information about all the data, including the number and IDs of elements of a mesh and data, the number and IDs of time steps, and the number and IDs of the values of the data. For example, the feature information may be implemented in a meta.xml form, and the directory structure of data that forms a single data set based on meta information described in meta.xml may be checked.

Furthermore, the meta data unit 110 may include a list of values calculated through CFD and a mesh corresponding to a location where the values are present.

Furthermore, for parallel I/O, data needs to be divided as far as possible without damaging the structure of the data and stored. The structure of a directory for parallel I/o has been illustrated in FIG. 1. meta.xml that describes information about all the data is present at the top of the data directory. The structure of the directory is divided based on the number and IDs of elements, the number and IDs of time steps, and the number and IDs of values that are described in meta.xml.

In the mesh directory unit 120, a directory of an element unit and the directory of each time step within the element have been structured in a grid structure with respect to the mesh. That is, a grid structure used for the calculation of CFD is stored in the mesh directory unit 120. In the grid, a directory is structured for each element configured by a user. The directory of each time step is configured within the element by taking time-varying data into consideration. The mesh divided for parallel processing is stored for each time step. A mesh may be changed or may not be changed over time depending on the type of CFD calculation. If a mesh is changed for each time step, the number of time steps present in a mesh directory is the same as that of times steps described in meta.xml. If a mesh type is static, a time step directory includes only single ts00000000.

Furthermore, one or more block data may be stored in a file form in the directory of each time step of the mesh directory unit 120. One or more block data may be stored in a file form in the directory of each value of the data directory unit 110.

Furthermore, the mesh directory unit 120 is redefined as a list of elements. Each point of the mesh is represented in order of x, y, and z. An element has items of a unique ID and value and dimension. The ID is a unique ID that identifies the element in a single data set. The value may be a list of physical values of the element. That is, a mesh includes coordinates corresponding to the number of i, j, and k values corresponding to a dimension. The size of the mesh is i, k, k values. When the size of the mesh is stored in a file, it is stored in order of x, y, and z values.

Furthermore, a single element is formed of several blocks. The dimension of the mesh of the blocks is several in a single element. The dimensions describe different dimensions present in the element. Each dimension may be formed of a list of blocks having unique IDs and dimension sizes and the same dimension.

Furthermore, in the data directory unit 130, a directory of an element unit and the directory of each time step within an element have been structured in a grid structure with respect to data, and the directory of one or more values has been structured in the directory of each time step.

Furthermore, the structure of the data directory unit 130 is the same as that of the mesh directory unit 120 up to the element and the time step. Efficiency of parallel I/O is improved because data is divided into several values and stored. The data directory unit 130 is configured as the directory of each value for each time step directory. Data for each block divided by taking parallel processing into consideration is stored in a blk********.glv file form in a value directory. Such a structure can maximize parallel efficiency in a file sharing system for efficiently processing a large capacity of data. In a file sharing system, in order for cluster nodes to efficiently perform parallel I/O, a CEO result file must be divided as far as possible. If data is divided and formed in a structure, such as that of FIG. 1, the nodes of a cluster can check a directory structure and read a file allocated to each node based on only information described in meta.xml.

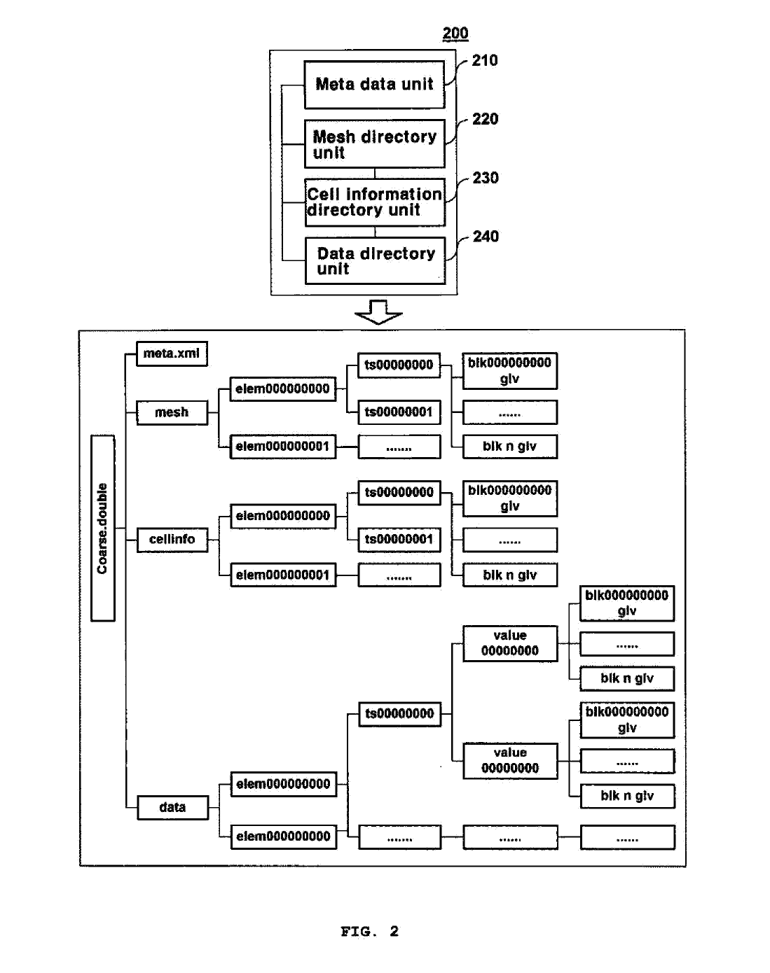

FIG. 2 is a diagram illustrating an example of a recording medium on which data has been recorded in the data file format structure of an unstructured grid for visualizing a large capacity of CFD parallel data in accordance with another embodiment of the present invention.

As illustrated in FIG. 2, the recording medium 200 on which data has been recorded in the data file format structure of an unstructured grid for visualizing a large capacity of CFD parallel data in accordance with another embodiment of the present invention includes a meta data unit 210, a mesh directory unit 220, a cell information (Cellinfo) directory unit 230, and a data directory unit 240.

The meta data unit 210 describes feature information about all the data, including the number and IDs of elements of a mesh, cell information, and data, the number and IDs of time steps, and the number and IDs of the values of the data.

Furthermore, the meta data unit 210 may include a structured grid, the number of time steps, value information about a value list, the number and IDs of elements, the number of blocks, the number of dimensions of a mesh, and element information about the locations of points.

In the mesh directory unit 220, a directory of an element unit and the directory of each time step within an element have been structured in a grid structure with respect to a mesh.

The cell information directory unit 230 stores cell information formed by the point of each block stored in a mesh. A directory of an element unit and the directory of each time step within an element have been structured in a grid structure with respect to the cell information.

Furthermore, the cell information directory unit 230 is information that represents a mesh of an unstructured grid along with the mesh. The directory structure and number of files of the cell information directory unit 230 are the same as those of the mesh. The format of blk******.glv file, that is, each individual file, and stored information are different from those of the mesh. In the case of an unstructured grid, if a mesh is great, cell information increases in geometrical progression. If cell information is divided and stored, efficiency of parallel I/O can be further improved.

Furthermore, the mesh directory unit 230 is redefined as a list of elements. Each point of the mesh is represented in order of x, y, and z. An element has items of a unique ID and value and dimension. The ID is a unique ID that identifies the element in a single data set. The value may be a list of physical values of the element. That is, a mesh includes coordinates corresponding to the number of i, j, and k values corresponding to a dimension. The size of the mesh is i, k, k values. When the size of the mesh is stored in a file, it is stored in order of x, y, and z values.

In this case, a single element is formed of several blocks. The dimension of the mesh of the blocks is several in a single element. The dimensions describe different dimensions present in the element. Each dimension may be formed of a list of blocks having unique IDs and dimension sizes and the same dimension.

Furthermore, in the data directory unit 240, a directory of an element unit and the directory of each time step within an element have been structured in a grid structure with respect to data, and the directory of one or more values has been structured in the directory of each time step.

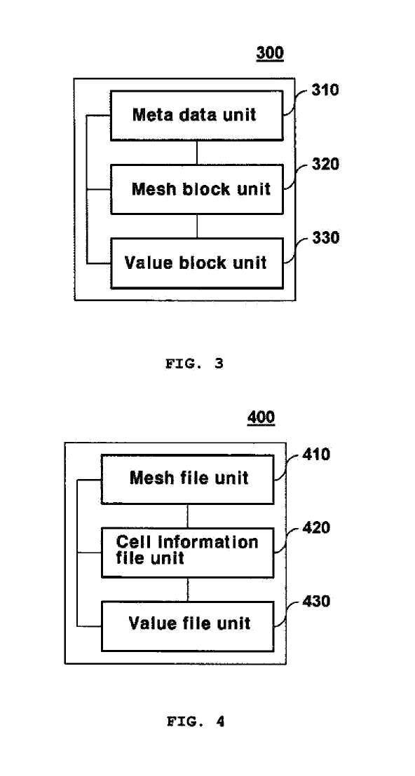

FIG. 3 is a diagram illustrating an example of recording medium on which data has been recorded in the binary data file format structure of a structured grid for visualizing a large capacity of CFD parallel data in accordance with another embodiment of the present invention.

As illustrated in FIG. 3, the recording medium 300 on which data has been recorded in the binary data file format structure of a structured grid for visualizing a large capacity of CFD parallel data n accordance with another embodiment of the present invention includes a meta data unit 310, a mesh block unit 320, and a value block unit 330.

The meta data unit 310 describes feature information about a mesh that determines the size of a block based on values of i, j, and k corresponding to a dimension and all the data including values regarding the values of values having the points of the mesh.

The mesh block unit 320 describes the grid point coordinates of a mesh, describes coordinates corresponding to the number of i, j, and k values corresponding to a dimension, and stores a binary data format corresponding to the size of each block described in the meta data unit.

Furthermore, the mesh block unit 320 may separate a file with respect to a mesh in which values of i, j, and k described in a dimension are different and store the separated files in order of x, y, and z.

Furthermore, the mesh block unit 320 may describe the number of points to which a corresponding block belongs (mesh dimension size) and the coordinates of the points in a mesh type, and may describe the coordinate system of the points of the mesh in a mesh dimension.

The value block unit 330 describes a physical value that may be owned by a point of a mesh.

Furthermore, the value block unit 330 may describe the number of points to which a corresponding block belongs (mesh dimension size) and the data type of a value.

FIG. 4 is a diagram illustrating an example of a recording medium on which data has been recorded in the binary data file format structure of an unstructured grid for visualizing a large capacity of CFD parallel data in accordance with another embodiment of the present invention.

As illustrated in FIG. 4, the recording medium 400 on which data has been recorded in the binary data file format structure of an unstructured grid for visualizing a large capacity of CFD parallel data in accordance with another embodiment of the present invention includes a mesh file unit 410 and the cell information (Cellinfo) file unit 420, and a value file unit 430.

The mesh file unit 410 describes the coordinates of mesh points. That is, the mesh file unit 410 may describe the number of points that form a mesh with respect to the points of the mesh, the number of cells formed by the points, and the number of points of a cell that belongs to various cells formed by the points and that has the greatest number of points.

The cell information (Cellinfo) file unit 420 describes information about a cell formed of points. That is, the cell information (Cellinfo) file unit 420 may store cell information, corresponding to a single mesh block, in a form including a cell information list, a cell type array, and a cell location array.

Furthermore, the cell information list is stored in each mesh block one by one, and stores information about a cell. The cell type array stores the type of a cell by the number of cells. The number of points that form a single cell is determined depending on a cell type. The cell location array may store an offset on the cell information list where cell information is placed.

The value file unit 430 represents values calculated with respect to each mesh. That is, in the value file unit 430, data may be stored in an element directory, a time step directory, and a value directory. Actual values corresponding to pressure, density, and vorticity may be stored.

Furthermore, if a value present in an element directory is cell-centered, the value file unit 430 stores data by the number of cells. If a value present in an element directory is a point, the value file unit 430 stores data by the number of points. The value nDim may be 1 in the case of scalar, the value nDim may be 2 in the case of a two-dimensional vector Ventor, and the value nDim may be 3 in the case of a three dimension.

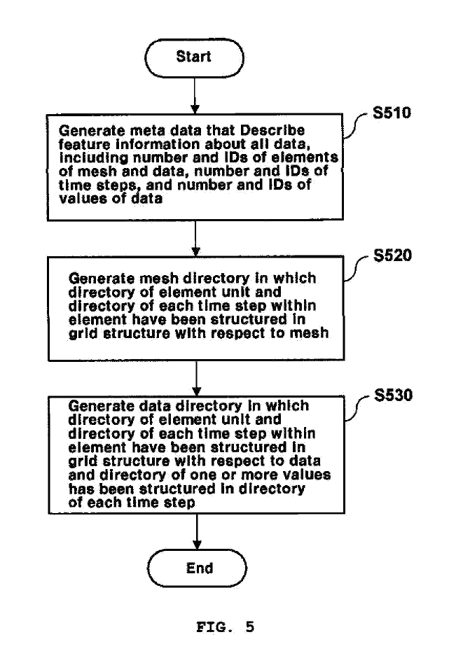

FIG. 5 is a diagram illustrating an operating flowchart illustrating a method of generating a data file format structure of a structured grid for visualizing a large capacity of CFD parallel data in accordance with an embodiment of the present invention.

In an embodiment or another embodiment of the present invention, control means, such a microprocessor, generates data in a data file format structure for the visualization of CFD parallel data and stores the generated data in the recording medium 100, 200, 300, or 400.

First, the control means generates meta data that describes feature information about all the data, including the number and IDs of elements of a mesh and data, the number and IDs of time steps, and the number and IDs of the values of the data (S510).

That is, the control means describes a list of values, calculated through CFD, and information about a mesh corresponding to a location where the values are present in meta data in accordance with a program, such as that illustrated in FIG. 6. FIG. 6 is a diagram illustrating an example of the meta data in accordance with an embodiment of the present invention. As illustrated in FIG. 6, in the case of a structured grid, the control means describes the number of time steps, a total number of blocks, and a value list with respect to the meta data. In the case of a list of values calculated through CFD calculation, the control means describes the unique IDs of values and a value description with respect to the meta data. The control means describes 1 in the case of scalar, 2 or 3 in the case of vector, and a data type corresponding to a value. The control means stores the generated meta data in the meta data unit 110.

Next, the control means generates a mesh directory in which a directory of an element unit and the directory of each time step within an element have been structured in a grid structure with respect to the mesh (S520).

In this case, one or more block data may be stored in a file form in the directory of each time step of the mesh directory, and one or more block data may be stored in a file form in the directory of each value of the data directory. The control means stores the generated mesh directory in the mesh directory unit 120.

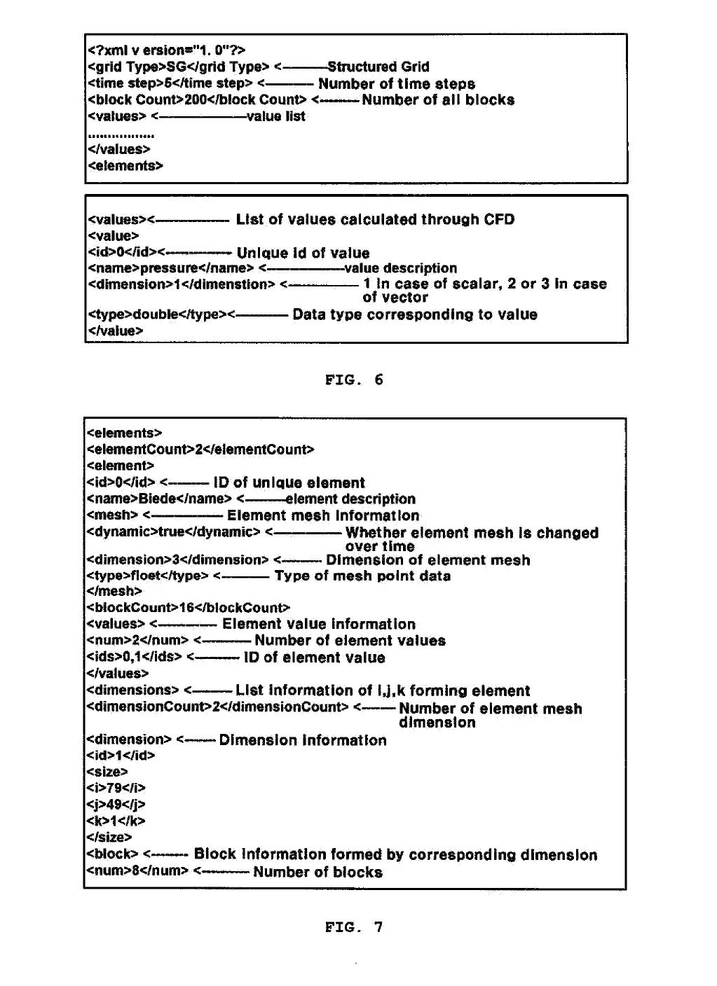

Furthermore, the mesh directory unit 120 is redefined as a list of elements. Each point of the mesh is represented in order of i, j, and k, As illustrated in FIG. 7, the element includes the items of a unique ID, value, and dimension. The ID may be a unique ID to identify an element in a single data set, and the value may be a list of physical values that may be owned by the element. A single element is formed of several blocks. The dimension of the mesh of a block is plural in a single element. The dimensions describe different dimensions present in the element. Each dimension may be formed of a list of blocks having unique IDs and dimension sizes and the same dimension. FIG. 7 is a diagram illustrating an example of the elements of a mesh directory in the data file format structure of a structured grid in accordance with an embodiment of the present invention. As illustrated in FIG. 7, the control means may describe whether the unique ID of an element, an element description, element mesh information, and an element mesh are changed over time with respect to the element and may describe the dimension of an element mesh, the type of mesh point data, element value information, the number of element values, the ID of an element value, different i, j, k list information that form an element, the number of element mesh dimensions, dimension information, block information formed of a corresponding dimension, the number of blocks, and a block ID list. In this case, the size of a mesh is i, j, k values, and the values are stored in order of x, y, and z values when they are stored in a file.

Next, the control means generates a data directory in which a directory of an element unit and the directory of each time step within an element have been structured in a grid structure with respect to data and the directory of one or more values has been structured in the directory of each time step (S530).

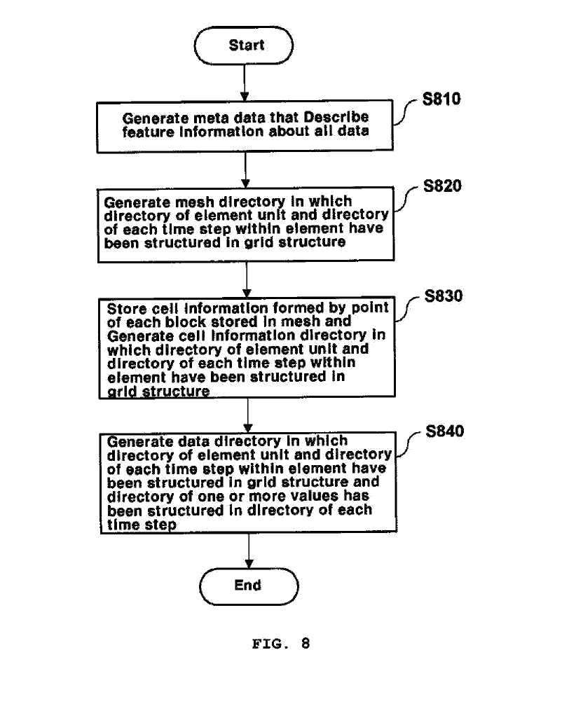

FIG. 8 is a diagram illustrating an operating flowchart illustrating a method of generating the data file format structure of an unstructured grid for visualizing a large capacity of CFD parallel data in accordance with another embodiment of the present invention.

As illustrated in FIG. 8, the control means generates meta data that describes feature information about all the data including the number and IDs of elements of a mesh, cell information, and data, the number and IDs of time steps, and the number and IDs of the values of the data (S810).

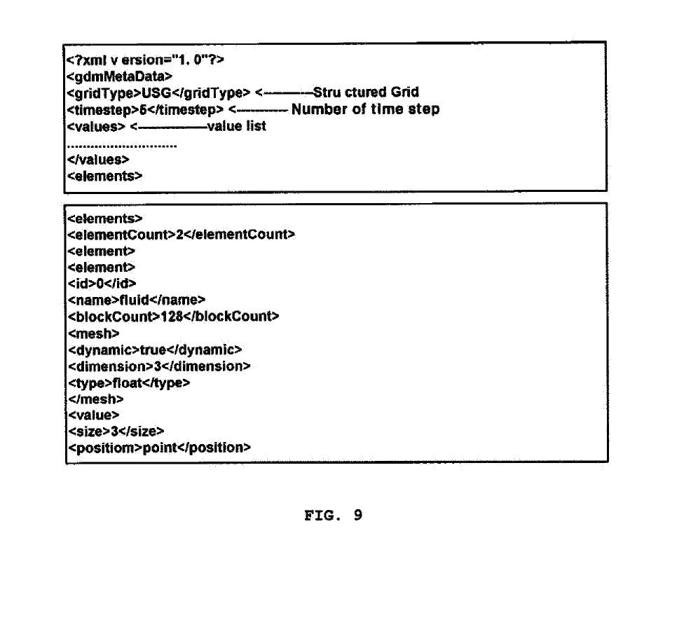

In this case, the control means stores the generated meta data in the meta data unit 210 and may describe the meta data, including a structured grid, the number of time steps, value information about a value list, the number and IDs of elements, the number of blocks, the number of dimensions of the mesh, and element information about the locations of points, as illustrated in FIG. 9. FIG. 9 is a diagram illustrating an example of meta data formed of values and elements in the data file format structure of an unstructured grid in accordance with an embodiment of the present invention. As illustrated in FIG. 9, as in the structured grid, an overall structure of the meta data are formed of values and elements. However, in terms of a data structure, the unstructured grid does not include information about a dimension in an element because the number of points is not determined depending on the dimension. In the case of unstructured grid data, position information about each value is added because the number of data of the value is changed depending on whether each value is present in a point or not.

Next, the control means generates a mesh directory in which a directory of an element unit and the directory of each time step within an element have been structured in a grid structure with respect to the mesh, as illustrated on the lower side of FIG. 2 (S820).

Next, the control means stores cell information, formed by the point of each block stored in the mesh, in the cell information directory unit 230 and generates a cell information directory in which the directory of an element unit and the directory of each time step within an element have been structured in a grid structure with respect to the cell information (S830).

In this case, the cell information directory is redefined as a list of elements. Each point of the mesh may be represented in order of i, j, and k. The element may include the items of a unique ID, value, and dimension. The ID may be a unique ID to identify an element in a single data set. The value may be a list of physical values owned by the element.

Furthermore, a single element is formed of several blocks. The dimension of the mesh of the block is plural in the single element. The dimensions describe different dimensions present in the element. The dimension may be formed of a list of blocks having unique IDs, dimension sizes, and the same dimension.

Furthermore, since the cell information directory is information that represents a mesh of an unstructured grid along with the mesh, the directory structure and number of files of the cell information directory are the same as those of the mesh. In this case, the format of a blk*******.glv file, that is, each individual file, and stored information are different. In the case of an unstructured grid, if a mesh is great, cell information increases in geometrical progression. Accordingly, if cell information is divided and stored, efficiency of parallel I/O can be further improved

Next, the control means generates a data directory in which a directory of an element unit and the directory of each time step within an element have been structured in a grid structure and the directory of one or more values has been structured in the directory of each time step with respect to data (S840).

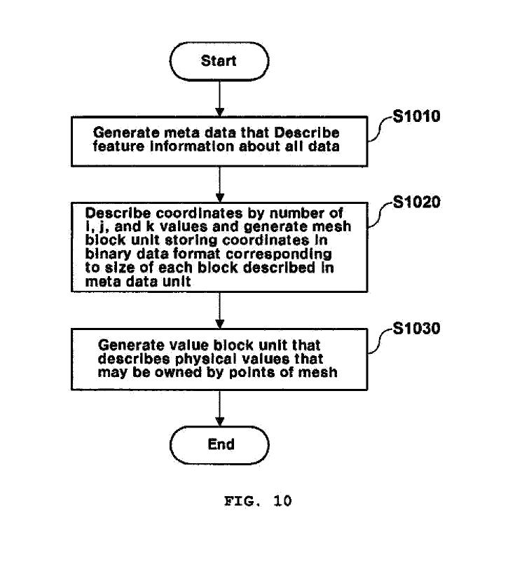

FIG. 10 is a diagram illustrating an operating flowchart illustrating a method of generating the binary data file format structure of a structured grid for visualizing a large capacity of CFD parallel data in accordance with another embodiment of the present invention.

As illustrated in FIG. 10, the control means generates meta data that describes feature information about all the data, including a mesh that determines the size of a block and a value regarding the value of a value owned by the points of the mesh based on the values of i, j, and k corresponding to a dimension (S1010).

Next, the control means describes the grid point coordinates of the mesh with respect to the mesh, and generates a mesh block unit that describe coordinates by the number and k values corresponding dimension and stores the coordinates in a binary data format corresponding to the size of each block described in the meta data unit (S1020).

That is, the control means describes the grid point coordinates of the mesh and stores the described grid point coordinates in each mesh/elem*******/ts********/blk******.glv file form. The coordinates are present in a mesh item of meta.xml by the number of i, j, and k values corresponding to a dimension. The size of the mesh is i, k, k values and stored in order of x, y, and z values when the mesh is stored in a file. In this case, the mesh block unit 320 may separate a blk*******.glv file with respect to another mesh in which the values of i, j, and k described in the dimension are different.

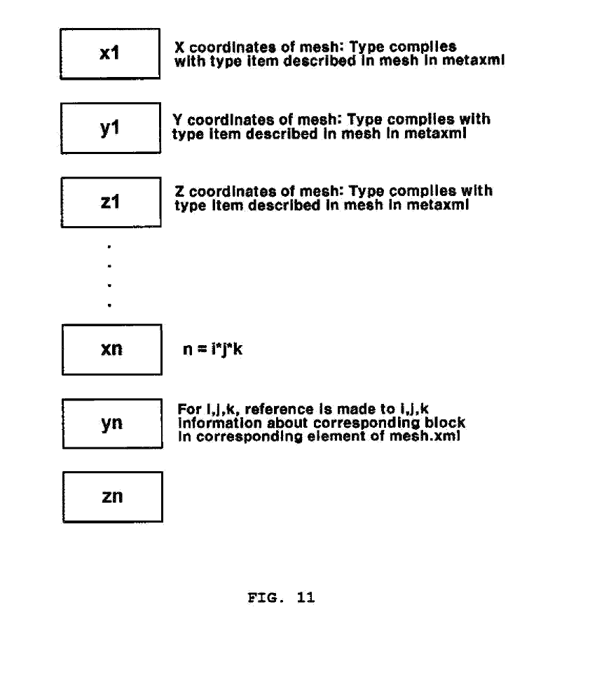

Furthermore, the control means describes the number of points to which a corresponding block belongs (mesh dimension size) and the coordinates of the point in a mesh type the mesh block unit 320, and may describe the coordinate system of the points of the mesh in a mesh dimension as illustrated in FIG. 11. FIG. 11 is a diagram illustrating a case where a mesh dimension is 3 in the binary data file format structure of a structured grid in accordance with an embodiment of the present invention. As illustrated in FIG. 11, the coordinates may be stored in a data format corresponding to a size described in each block of meta.xml as binary data. In FIG. 11, only x is present in the case of 1 and only x and y are present in the case of 2. The size of a block 1 in a mesh corresponding to the time step 1 of an element 0 may be determined as follows based on the data described in meta.xml.

A mesh dimension size to which the block 1 belongs: 79*49*1 (the number of points)

Type of the mesh: float (a data type that describes the coordinates of a point is float)

A mesh dimension: 3 (the coordinate system of a point is x, y, and z, that is, three dimension)

A total mesh size stored in the block 1: 79*49*1*size(float)*3

Accordingly, a total of 79*49*1*3 floats may only to be read with respect to Coarse.double/mesh/elem00000000/ts00000000/blk00000001.glv.

Next, the control means generates a value block unit that describes physical values that may be owned by the points of the mesh (S1030).

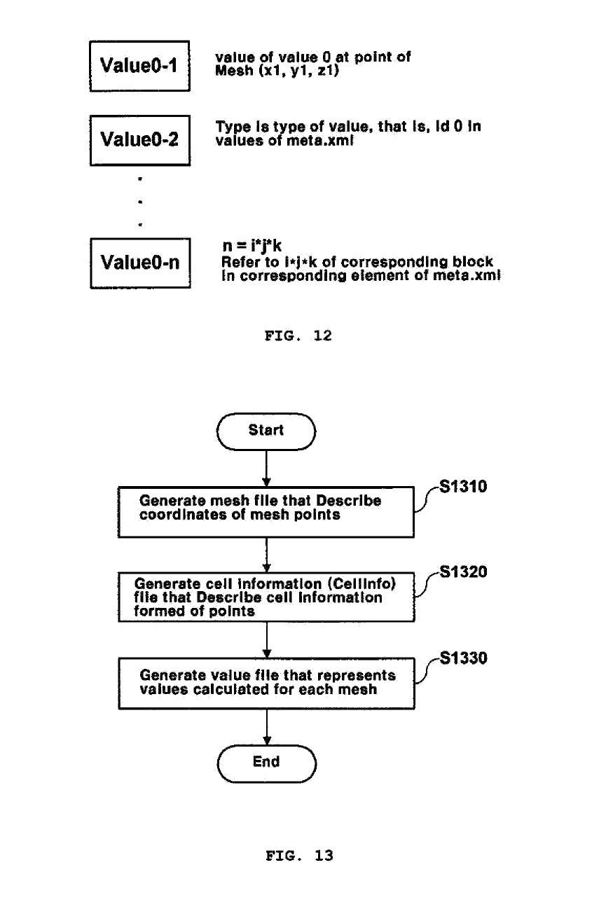

In this case, as illustrated in FIG. 12, the control means may describe the number of points (mesh dimension size) and the data type of a value to which a corresponding block belongs in the value block unit 330.

That is, the value block is stored in a /data/elem********/ts********/blc********.glv file form. The number and form of data complies with a format described in meta.xml. FIG. 12 is a diagram illustrating a case where a value is zero (0) in the binary data file format structure of a structured grid in accordance with an embodiment of the present invention. In accordance with meta.xad, a value 0 is pressure. If a corresponding block is 1, a total data size may be calculated as follows with reference to information about meta.xml to which the block 1 belongs.

A mesh dimension size to which the block 1 belongs: 79*49*1 (the number of points)

The data type of value 0: float (a data type describing the coordinates of a point is float)

A total data size=79*49*1*sizeof (float)

Accordingly, 70*49*1 floats have only to be read and process data/value000000000/ts0000000/value00000000/blk00000001.glv.

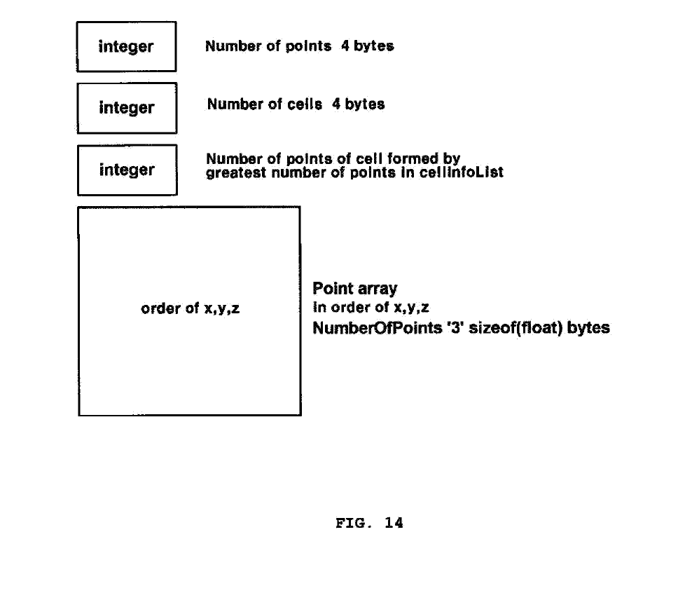

FIG. 13 is a diagram illustrating an operating flowchart illustrating a method of generating the binary data file format structure of an unstructured grid in accordance with another embodiment of the present invention.

As illustrated in FIG. 13, the control means generates a mesh file that describes the coordinates of mesh points (S1310).

In this case, the mesh is a list of the points of the mesh. As illustrated in FIG. 14, the control means may describe the number of points forming the mesh, the number of cells formed by the points, and the number of points of a cell that belongs to various cells formed by the points and that has the greatest number of points in the mesh file. FIG. 14 is a diagram illustrating the structure of a mesh file in the binary data file format structure of an unstructured grid in accordance with another embodiment of the present invention. In FIG. 14, NumberOfPoints is the number of points forming a mesh, and NumberOfCells is the number of cells formed by the points. MaxCellSize is the number of points of a cell that belongs to various cells formed by the points and that has the greatest number of points. They are information necessary to predict the size of memory when cell information is configured.

Next, the control means generates a cell information (Cellinfo) file that describes cell information formed of the points (S1320).

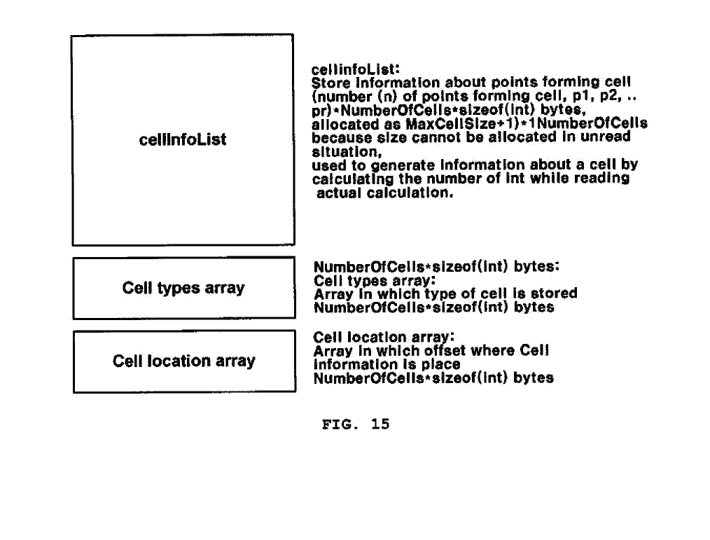

Furthermore, the control means may store cell information, corresponding to a single mesh block, in the cell information file as a cell information list, a cell type array, and a cell location array, as illustrated in FIG. 15. FIG. 15 is a diagram illustrating the structure of the cell information file in the binary data file format structure of an unstructured grid in accordance with another embodiment of the present invention. In FIG. 15, the cell information list is stored in each mesh block one by one, and is a file that stores information about cells. The cell type array stores the type of cell by the number of cells. The number of points that forms a single cell is determined by a cell type, and an offset where cell information is placed in the cell information list may be stored in the cell location array.

That is, the cell information list stores information about points that forms a cell (the number of points(n), p1, p2, . . . , pn) forming a cell *NumberOfCells sizeof(int) bytes). An array size is allocated (allocated as (MaxCellSize+1)*NumberOfCells) with reference to MaxCellSize. The array size is used to generate information about a cell by calculating the number of Int while reading actual calculation. The cell type array is an array in which the type of a cell (NumberOfCells*sizeof(int) bytes) is stored. The cell location array is an array in which offset (NumberOfCells sizeof(int) bytes) where cell information is placed.

Next, the control means generates a value file that represents values calculated for each mesh (S1330).

In this case, in the value file, data may be stored in an element directory, a time step directory, and a value directory. Actual values corresponding to pressure, density, and vorticity may be stored.

Furthermore, if a value present in the element directory is cell-centered, the value file stores data by the number of cells. If a value present in an element directory is a point, the value file unit 430 stores data by the number of points. The value nDim may be 1 in the case of scalar, the value nDim may be 2 in the case of a two-dimensional vector Ventor, and the value nDim may be 3 in the case of a three dimension. The data array is NumberofTuples*nDim*sizeof(type), and the dimension and type of a value, that is, id=0, in the value list of meta.xml, are incorporated in nDim and the type.

As described above, in accordance with the present invention, in visualizing a large capacity of CFD data by processing the CFD data in parallel, data is generated in a data file format structure capable of increasing processing speed of the data, and a large capacity of data of the generated data file format structure is stored and recorded. Accordingly, the recording medium on which data has been recorded in a data film format structure for visualizing a large capacity of CFD parallel data and the method of generating the data file format structure, which are capable of visualizing a large capacity of data by processing the data within a short time even without a separate analysis tool, can be realized.

Those skilled in the art to which the present invention pertains will understand that the present invention may be implemented in other detailed forms without changing the technical spirit or indispensable characteristics of the present invention. Accordingly, it will be understood that the aforementioned embodiments are illustrative and not limitative from all aspects. The scope of the present invention is defined by the appended claims rather than the detailed description, and the present invention should be construed as covering all modifications or variations derived from the meaning and scope of the appended claims and their equivalents.

### INDUSTRIAL APPLICABILITY

The present invention may be applied to a recording medium on which data has been recorded in a data film format structure for visualizing a large capacity of CFD parallel data and a method of generating the data file format structure, which are capable of visualizing a large capacity of data by processing the data within a short time even without a separate analysis tool by generating a large capacity of data in a data file format structure of structured grid or unstructured grid and storing or recording the generated data in visualizing large capacity of CFD data in parallel by processing the CFD data.

1. A recording medium on which data has been recorded in a data file format structure of a structured grid for visualizing a large capacity of CFD parallel data, wherein the data file format structure of the structured grid comprises:
a meta data unit which describes feature information about all data, comprising a number and IDs of elements of a mesh and data, a number and IDs of time steps, and a number and IDs of values of the data;
a mesh directory unit in which a directory of an element unit and a directory of each of the time steps within the element have been structured in the grid structure with respect to the mesh; and
a data directory unit in which a directory of an element unit and a directory of each of the time steps within the element have been structured in the grid structure and a directory of one or more values has been structured in the directory of each time step with respect to the data.

2. The recording medium of claim 1, wherein the meta data unit comprises a list of values calculated through CFD and the mesh corresponding to locations where the values are present.

3. The recording medium of claim 1, wherein:
one or more block data is stored in a file form in the directory of each time step of the mesh directory unit, and
one or more block data is stored in a file form in a directory of each value of the data directory unit.

4. The recording medium of claim 1, wherein the mesh directory unit is redefined as a list of the elements, each point of the mesh is represented in order of x, y, and z, the element comprises items of a unique ID, value, and dimension, the ID is a unique ID to identify the element in a single data set, and the value is a list of physical values that are owned by the element.

5. The recording medium of claim 4, wherein each element is formed of several blocks, a plurality of dimensions of the mesh of the block is present in a single element, the dimensions describe different dimensions present in the element, and the dimension comprises a list of blocks having unique IDs and dimension size and an identical dimension.

6. A recording medium on which data has been recorded in a data file format structure of an unstructured grid for visualizing a large capacity of CFD parallel data, wherein the data file format structure of the unstructured grid comprises:
a meta data unit which describes feature information about all data, comprising a number and IDs of elements of a mesh, cell information, and data, a number and IDs of time steps, and a number and IDs of values of the data;
a mesh directory unit in which a directory of an element unit and a directory of each of the time steps within the element have been structured in the grid structure with respect to the mesh;
a cell information directory unit which stores information about a cell formed by points of a block designated within the mesh and in which a directory of an element unit and the directory of each of the time steps within the element have been structured in the grid structure with respect to the cell information; and
a data directory unit in which a directory of an element unit and a directory of each of the time steps within the element have been structured in the grid structure and a directory of one or more values has been structured in the directory of each time step with respect to the data.

7. The recording medium of claim 6, wherein the meta data unit comprises the unstructured grid, a number of time steps, value information about a value list, a number and IDs of elements, a number of blocks, a number of dimensions of the mesh, and element information about locations of points.

8. The recording medium of claim 7, wherein the cell information directory unit is redefined as a list of the elements, each point of the mesh is represented in order of x, y, and z, the element comprises items of a unique ID, value, and dimension, the ID is a unique ID to identify the element in a single data set, and the value is a list of physical values that are owned by the element.

9. The recording medium of claim 8, wherein each element is formed of several blocks, a plurality of dimensions of the mesh of the block is present in a single element, the dimensions describe different dimensions present in the element, and the dimension comprises a list of blocks having unique IDs and dimension size and an identical dimension.

10. A recording medium on which data has been recorded in a binary data file format structure of a structured grid for visualizing a large capacity of CFD parallel data, wherein the binary data file format structure of the structured grid comprises:
a meta data unit which describes feature information about all data, comprising a mesh that determines a size of a block based on values of i, j, and k corresponding to a dimension and a value regarding a value of a value owned by points of the mesh;
a mesh block unit which describes grid point coordinates of the mesh with respect to the mesh, describes coordinates corresponding to a number of i, j, and k values corresponding to the dimension, and stores the coordinates a binary data format corresponding to a size of each block described in the meta data unit; and
a value block unit which describes a physical value in the points of the mesh.

11. The recording medium of claim 10, wherein the mesh block unit separates a file of a mesh in which the values of i, j, and k described in the dimension are different and stores the separated file.

12. The recording medium of claim 10, wherein the mesh block unit describes a number of points to which a corresponding block belongs (mesh dimension size) and the coordinates of the points in a mesh type and describes coordinate system of the points of the mesh in a mesh dimension.

13. The recording medium of claim 10, wherein the value block unit describes a number of points to which a corresponding block belongs (mesh dimension size) and a data type of a value.

14. A recording medium on which data has been recorded in a binary data file format structure of an unstructured grid for visualizing a large capacity of CFD parallel data, wherein the binary data file format structure of the unstructured grid comprises:
a mesh file unit which describes coordinates of a mesh point;
a cell information (Cellinfo) file unit which describes cell information formed of points; and
a value file unit representing values calculated for each mesh.

15. The recording medium of claim 14, wherein the mesh file unit describes a number of points that form the mesh with respect to the points of the mesh, a number of cells formed by the points, and a number of points of a cell that belongs to various cells formed by the points and that has a greatest number of points.

16. The recording medium of claim 14, wherein the cell information file unit stores cell information corresponding to a single mesh block in a form comprising a cell information list, a cell type array, and a cell location array.

17. The recording medium of claim 16, wherein:
the cell information list is stored in each mesh block one by one and is a file for storing information about a cell,
the cell type array stores a type of a cell by a number of cells,
the number of points forming a single cell is determined by the cell type, and
the cell location array stores an offset where the cell information is placed in the cell information list.

18. The recording medium of claim 14, wherein in the value file unit, data is stored in an element directory, a time step directory, and a value directory, and an actual value corresponding to a physical value is stored.

19. The recording medium of claim 18, wherein the value file unit stores data by a number of cells if a value present in the element directory is cell-centered and stores data by a number of points if a value present in the element directory is a point, the value nDim is 1 in case of scalar, the value nDim is 2 in case of a two-dimensional vector Ventor, and the value nDim is 3 in case of a three dimension.

20. A method of generating a data file format structure of a structured grid for visualizing a large capacity of CFD parallel data, the method comprising steps of:
(a) generating meta data which describes feature information about all data, comprising a number and IDs of elements of a mesh and data, a number and IDs of time steps, and a number and IDs of values of the data;
(b) generating a mesh directory in which a directory of an element unit and a directory of each of the time steps within the element have been structured in the grid structure with respect to the mesh; and
(c) generating a data directory in which a directory of an element unit and a directory of each of the time steps within the element have been structured in the grid structure and a directory of one or more values has been structured in the directory of each time step with respect to the data.

21. The method of claim 20, wherein in the step (a), the meta data comprises a list of values calculated through CFD and the mesh corresponding to locations where the values are present.

22. The method of claim 20, wherein in the step (b), one or more block data is stored in a file form in the directory of each time step of the mesh directory unit, and one or more block data is stored in a file form in a directory of each value of the data directory unit.

23. The method of claim 20, wherein in the step (b), the mesh directory is redefined as a list of the elements, each point of the mesh is represented in order of x, y, and z, the element comprises items of a unique ID, value, and dimension, the ID is a unique ID to identify the element in a single data set, and the value is a list of physical values that are owned by the element.

24. The method of claim 23, wherein each element is formed of several blocks, a plurality of dimensions of the mesh of the block is present in a single element, the dimensions describe different dimensions present in the element, and the dimension comprises a list of blocks having unique IDs and dimension size and an identical dimension.

25. A method of generating a data file format structure of an unstructured grid for visualizing a large capacity of CFD parallel data, comprising steps of:
(a) generating meta data which describes feature information about all data, comprising a number and IDs of elements of a mesh, cell information, and data, a number and IDs of time steps, and a number and IDs of values of the data;
(b) generating a mesh directory in which a directory of an element unit and a directory of each of the time steps within the element have been structured in the grid structure with respect to the mesh;
(c) generating a cell information directory which stores information about a cell formed by points of a block designated within the mesh and in which a directory of an element unit and the directory of each of the time steps within the element have been structured in the grid structure with respect to the cell information; and
(d) generating a data directory in which a directory of an element unit and a directory of each of the time steps within the element have been structured in the grid structure and a directory of one or more values has been structured in the directory of each time step with respect to the data.

26. The method of claim 25, wherein in the step (a), the unstructured grid, a number of time steps, value information about a value list, a number and IDs of elements, a number of blocks, a number of dimensions of the mesh, and element information about locations of points are included in the meta data.

27. The method of claim 26, wherein in the step (c), the cell information directory is redefined as a list of the elements, each point of the mesh is represented in order of x, y, and z, the element comprises items of a unique ID, value, and dimension, the ID is a unique ID to identify the element in a single data set, and the value is a list of physical values that are owned by the element.

28. The method of claim 27, wherein each element is formed of several blocks, a plurality of dimensions of the mesh of the block is present in a single element, the dimensions describe different dimensions present in the element, and the dimension comprises a list of blocks having unique IDs and dimension size and an identical dimension.

29. A method of generating a binary data file format structure of a structured grid for visualizing a large capacity of CFD parallel data, the method comprising steps of:
(a) generating meta data which describes feature information about all data, comprising a mesh that determines a size of a block based on values of i, j, and k corresponding to a dimension and a value regarding a value of a value owned by points of the mesh;
(b) generating a mesh block unit which describes grid point coordinates of the mesh with respect to the mesh, describes coordinates corresponding to a number of i, j, and k values corresponding to the dimension, and stores the coordinates a binary data format corresponding to a size of each block described in the meta data unit; and
(c) generating a value block unit which describes a physical value in the points of the mesh.

30. The method of claim 29, wherein in the step (b), the mesh block unit separates a file of a mesh in which the values of i, j, and k described in the dimension are different and stores the separated file.

31. The method of claim 29, wherein in the step (b), the mesh block unit describes a number of points to which a corresponding block belongs (mesh dimension size) and the coordinates of the points in a mesh type and describes coordinate system of the points of the mesh in a mesh dimension.

32. The method of claim 29, wherein in the step (b), the value block unit describes a number of points to which a corresponding block belongs (mesh dimension size) and a data type of a value.

33. A method of generating a binary data file format structure of an unstructured grid for visualizing a large capacity of CFD parallel data, wherein the method comprising steps of:
(a) generating a mesh file which describes coordinates of a mesh point;
(b) generating a cell information (Cellinfo) file which describes cell information formed of points; and
(c) generating a value file representing values calculated for each mesh.

34. The method of claim 33, wherein in the step (a), a number of points that form the mesh with respect to the points of the mesh, a number of cells formed by the points, and a number of points of a cell that belongs to various cells formed by the points and that has a greatest number of points are described in the mesh file.

35. The method of claim 33, wherein in the step (b), cell information corresponding to a single mesh block in a form comprising a cell information list, a cell type array, and a cell location array are stored in the cell information file.

36. The method of claim 35, wherein:
the cell information list is stored in each mesh block one by one and is a file for storing information about a cell,
the cell type array stores a type of a cell by number of cells,
the number of points forming a single cell is determined by the cell type, and
the cell location array stores an offset where the cell information is placed in the cell information list.

37. The method of claim 33, wherein in the step (c), in the value file, data is stored in an element directory, a time step directory, and a value directory, and an actual value corresponding to a physical value is stored.

38. The method of claim 37, wherein the value file stores data by a number of cells if a value present in the element directory is cell-centered and stores data by a number of points if a value present in the element directory is a point, the value nDim is 1 in case of scalar, the value nDim is 2 in case of a two-dimensional vector Ventor, and the value nDim is 3 in case of a three dimension.
